(19) United States
(12) Patent Application Publication
(10) Pub. No.: US 2026/0256165 A1
(43) Pub. Date: Sep. 3, 2026

(54) NON-DAIRY SOFT SERVE COMPOSITION AND METHOD FOR MANUFACTURING OF THE COMPOSITION

(71) Applicant: Oatly AB, MALMÖ (SE)

(72) Inventors: Hanna ANDERSSON, MALMÖ (SE); Ida ANDERSSON, MALMÖ (SE); Nellie OSSVAL, MALMÖ (SE)

(21) Appl. No.: 18/877,627

(22) PCT Filed: Jul. 1, 2022
(86) PCT No.: PCT/EP2022/068331

§ 371 Date: Dec. 20, 2024

(51) Int. Cl. A23G 9/20; A23G 9/34; A23G 9/42

(52) U.S. Cl. CPC A23G 9/20; A23G 9/34; A23G 9/42

(57) ABSTRACT

A non-dairy soft serve composition, the composition including: an oat-derived material including dry matter in an amount of 1 to 15% by weight of the soft serve composition; vegetable fat present in an amount of 0.5 to 10% by weight of the soft serve composition; sugars present in an amount of 5 to 25% by weight of the soft serve composition; maltodextrin present in an amount of 2 to 6% by weight of the soft serve composition; emulsifier and stabilizer blend; and water.

### FIELD OF THE INVENTION

The invention relates to a non-dairy soft serve composition, a method for producing a non-dairy soft serve, and a method for manufacturing of a non-dairy soft serve composition.

### TECHNICAL BACKGROUND

Soft serve is a term used to describe a soft type of ice cream, which contains mixed in air. The air content may have an effect on the taste or sensation of the finished product. Product with low quantities of air may be perceived and described as heavier or denser. Ice cream with higher air content may be perceived as creamier, smoother, and lighter and whiter in colour.

Soft serves are typically made from pre-mixed products using a special machine that provides freezing and aeration of the soft serve at the point of sale to consumers.

It is problematic but desirable to achieve stability of the pre-mix, for example concerning emulsion stability and shelf life.

Soft serves are traditionally made using a dairy base. A demand for dairy substitute products is currently increasing and has been increasing over several years, fueled by a desire from consumers to exclude or reduce the amount of animal products, such as dairy products, from their diet.

There is a further demand and need for dairy substitute products taking sustainability into account as well as health aspects, fueled by an interest in sustainability, vegetarianism, veganism as well as for improved health. In particular there is a demand for vegetable based or vegan non-dairy products.

Known soft serve compositions, such as non-dairy soft serve compositions, often requires a relatively high level of fat, which may be hardened fat, to provide desirable organoleptic properties of the soft serve, such as properties which may be described as creaminess, taste and mouth feel. Such soft serve compositions may be considered less desirable for health reasons. There is a desire but also a problem to provide non-dairy soft serve compositions that is low-fat and associated with desirable organoleptic properties.

It is problematic with soft serves, and in particular with non-dairy or vegan soft serves, to avoid crystal growth in the frozen product. It is yet further problematic to achieve desirable organoleptic or sensory properties of soft serves, in particular of non-dairy or vegan soft serves.

It is sometimes problematic with dairy replacement products, to substitute the dairy fat while at the same time maintaining organoleptic properties and meet a desire to use healthier and vegetable based ingredients, eg. vegetable fats.

There is, thus, a need for non-dairy soft serve composition with improved properties, such as organoleptic properties and/or based on ingredients taking sustainability and health aspects into account.

### SUMMARY

One object of the invention is to alleviate, at least in part, drawbacks and/or problems of prior art. One object of the invention is to provide a non-dairy vegetable soft serve composition that can maintain stable emulsion. Another object of the invention is to provide a soft serve composition that is low in fat, and/or is associated with desirable organoleptic properties.

According to a first aspect, there is provided a non-dairy soft serve composition, the composition comprising: an oat-derived material comprising dry matter in an amount of 1 to 15% by weight of the soft serve composition; vegetable fat present in an amount of 0.5 to 10% by weight of the soft serve composition; sugars present in an amount of 5 to 25% by weight of the soft serve composition; maltodextrin present in an amount of 2 to 6% by weight of the soft serve composition; emulsifier and stabiliser blend; and water.

A content of oat-derived material allows a source of desirable and vegetable nutrients to be included in the soft serve, such as, for example beta-glucan. The oat-derived material further allows for oat protein and oat fat to be included, together with, for example, any carbohydrates.

The specific composition, with the above stipulated levels of oat-derived material, vegetable fat, sugars, maltodextrin, emulsifier and stabilizer blend and water unexpectedly allows provision of a vegetable based soft serve associated with desirable emulsification properties and provides desirable organoleptic properties, while also providing stability of the composition over time, for example, in terms of a stable emulsion. With stable emulsion is intended an emulsion, of the soft serve composition, that stays emulsified over time. The soft serve composition may stay emulsified at least for one day, such as at least for several days, or at least for six months.

It is surprising and appreciated that the combination of the ingredients within their respective intervals together functions to provide the desirable properties of the soft serve composition.

The sugars may comprise one or more of sucrose, dextrose and sugars from glucose syrup. Such sugars and blends of sugars, at the specified level of sugars, have shown to provide pleasant taste of the soft serve as well being suitable for providing stable emulsion. It shall further be noted that the sugars and blends of sugars functions well in combination with any carbohydrates, such as sugar, provided by the content of oat-derived material.

The emulsifier and stabiliser blend may be present in an amount of 0.25-4% by weight of the soft serve composition, and the emulsifier and stabiliser blend may comprise one or more compounds selected from the group consisting of comprising mono- and di-glycerides of fatty acids, guar gum, and gellan gum.

The vegetable fat may comprise coconut fat. The coconut fat may be non-hydrogenated. The non-hydrogenated coconut oil may be referred to as coconut oil.

Such specific choice of fat for the soft serve composition in combination with the other ingredients of the composition, lends the soft serve a desirable creaminess, mouthfeel, richness and taste. At the same time, the level of fat can be kept low, such as, for example, around and between 3-4% by weight of the composition.

The water may be present in an amount of 55 to 75% by weight of the composition.

The oat-derived material may have been obtained from treatment of oats comprising degradation of starch.

The oat-derived material may be a liquid oat base or an oat drink, or a combination thereof.

The oat-derived material may be a deamidated oat-derived material.

Such a deamidated oat derived material, may be an oat-derived material wherein oat proteins have been subjected to deamidation and thereby converted to more water soluble proteins.

It has unexpectedly been found that presence of deamidated oat proteins in the soft serve composition plays a role in improving organoleptic properties and improved stability of emulsion of the soft serve composition.

The oat-derived material may comprise one or more of monosaccharides, disaccharides, for example, maltose, oligosaccharides, and fibers, including β-glucan, the oat derived material may further comprise oat protein and oat fat.

Such an oat-derived material allows adding complexity to the soft serve. Further, nutritional benefits may be added, for example by inclusion of β-glucan.

A non-dairy soft serve composition may be provided, wherein the oat-derived material may comprise dry matter in an amount of 5-10% by weight of the soft serve composition; the vegetable fat may be present in an amount of 2 to 5% by weight of the soft serve composition; the sugars may be present in an amount of 10 to 20% by weight of the soft serve composition, and may comprise sucrose and sugar from glucose syrup, and dextrose; the maltodextrin may be present in an amount of 3 to 5% by weight of the soft serve composition; the emulsifier and stabiliser blend may be present in an amount of 0.25 to 1.25% by weight of the soft serve composition; and the water may be present in an amount of 60 to 70% by weight of the soft serve composition.

It has been found that such a non-dairy soft serve composition lends the soft serve desirable properties, for example desirable organoleptic properties.

According to a second aspect, there is provided a method for producing a non-dairy soft serve from the non-dairy soft serve composition according to the first aspect, the method comprising: providing the non-dairy soft serve composition according to the first aspect; mixing in air; and freezing of the non-dairy soft serve composition, thereby obtaining a soft serve.

The mixing in air provides the soft serve with an overrun. The overrun may be, for example 100% or below, such as 30 to 70% overrun. In particular, the overrun may be 45% or above, such as 45 to 75% overrun.

The mixing in air and the freezing may be conducted, at least in part, simultaneously. The soft serve composition according to the first aspect may be manufactured with a water content suitable for producing a non-dairy soft serve. However, if, for any reason, it is deemed suitable to mix in additional water during the producing of a non-dairy soft serve, it shall be an option.

Thus, the method for producing a non-dairy soft serve from the non-dairy soft serve composition may further comprise adding water or aqueous solution.

The method for producing a non-dairy soft serve from the non-dairy soft serve composition may be performed using a soft serve apparatus.

Thereby, a soft serve with overrun may efficiently be made. Further, soft serve apparatuses or machines are readily available in shops, restaurants etc.

According to a third aspect there is provided a method for manufacturing of a non-dairy soft serve composition according to the first aspect, the method comprising:
providing a base composition comprising:
an oat-derived material, vegetable fat, sugars, maltodextrin, emulsifier and stabiliser blend, and water;
subjecting the base composition to heat treatment at a temperature above 125° C. followed by cooling to a temperature below 85° C.;
subjecting the base composition to homogenisation followed by cooling below 30° C., thereby obtaining the non-dairy soft serve composition.

The heat treatment at a temperature above 125° C. provides, for example, UHT, thereby allowing improved shelf-life. The heat treatment further improves properties of the base composition, such as improved absorbance of water of components of the base composition. The cooling to a temperature below 85° C., which lends the heat treated base composition a temperature suitable for further processing and minimizes risks which may be associated with prolonged heat treatment, such as negative effects on taste or nutritional values.

The homogenisation may be followed by cooling below 15° C., or within the range of 15 to 0° C., such as 15 to 5° C., for example around 11° C., or around 6° C.

The homogenization may, for example, be conducted at 200/50 bar pressure. The homogenisation may be conducted for example, using a two-stage homogeniser. It shall be realised that other suitable type of homogenization may be used, such as a one-stage homogenizer. Other pressures than the 200/50 bar may be used.

The vegetable fat may be subjected to melting by heating prior to being provided for the base composition.

Thereby, the vegetable fat may more efficiently be mixed in with other ingredients of the base composition. Further, solid, or semi-solid fats may be used with the method.

The method may further comprise mixing the base composition, following the providing the base composition, and preceding the subjecting the composition to heat treatment.

The mixing the base composition may initiate emulsification and/or homogenistation of the base composition. Further, components of the base composition, such as any proteins present, such as oat proteins from the oat derived material, may be allowed to hydrate, thus may provide improved emulsification and homogenisation.

The mixing the base composition may be associated with, or additionally comprise a holding time prior to the subjecting the base composition to heat treatment.

According to a furth aspect, there is provided a non-dairy soft serve comprising the composition according to the first aspect.

Such a non-dairy soft serve may be provided or served to a consumer. The non-dairy soft serve may be served, for example, in an ice-cream cone, or a beaker, in a glass, or on a plate, either alone or in combination with, for example, other type of ice-cream or confectionary items.

The above-mentioned features of the one aspect, when applicable, apply to any of the other aspects as well. In order to avoid undue repetition, reference between aspects are made.

### BRIEF DESCRIPTION OF THE DRAWINGS

Aspects of the present disclosure will now be described in more detail, with reference to the appended drawing.

FIG. 1 schematically illustrates an embodiment of a method for producing of a non-dairy soft serve.

FIG. 2 schematically illustrates an embodiment of a method for manufacturing a non-dairy soft serve composition.

### DETAILED DESCRIPTION OF THE INVENTION

The present invention will now be described more fully hereinafter. This invention may, however, be embodied in many different forms and should not be construed as limited to the embodiments set forth herein; rather, these embodiments are provided for thoroughness and completeness, and fully convey the scope of the invention to the skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realizations including that a non-dairy soft serve composition, as defined by the appended claims and examples and embodiments described herein, i.e. a non-dairy soft serve composition, comprising an oat-derived material, vegetable fat, sugars, maltodextrin, emulsifier and stabiliser blend, and water may be provided having beneficial or desirable properties.

The present inventors have, after extensive research and development found that a presence of an oat-derived material in the composition, with resulting benefits, have been made possible together with the other ingredients of the soft serve composition. Thus, soft serve compositions according to the present inventive concept, are achievable with desirable texture, organoleptic properties and emulsion stability, without hydrogenated fat and without further addition of protein. It has further been made possible to combine oat-derived material and other ingredients, which together form a desirable non-dairy soft serve composition, which composition further may be selected to be environmentally sustainable.

Non-dairy, as used herein, is intended to describe a composition essentially free from dairy components. In addition to being described as a non-dairy soft serve composition, the composition may be described as a plant-based, a vegetable, a vegan, and/or a vegetarian non-dairy soft serve composition. The non-dairy soft serve composition may be totally free from animal ingredients. However, the non-dairy soft serve composition may contain additives derived from animal sources, and still be according to embodiments described herein.

The soft serve compositions described herein, may be used as such for making of soft serves, for example using a suitable soft serve machine, without further additions. Thus, it shall be noted that the soft serve composition as discussed herein may also be describing the soft serve as such made therefrom, in terms of ingredients and levels of ingredients. The soft serve may, thus, be described as the soft serve composition in a frozen, and aerated, or having over-run, state.

According to the first aspect, there is provided a non-dairy soft serve composition, the composition comprising: an oat-derived material comprising dry matter in an amount of 1 to 15% by weight of the soft serve composition; vegetable fat present in an amount of 0.5 to 10% by weight of the soft serve composition; sugars present in an amount of 5 to 25% by weight of the soft serve composition; maltodextrin present in an amount of 2 to 6% by weight of the soft serve composition; emulsifier and stabiliser blend; and water.

It was found by the inventors, that it was possible to have a content of oat-derived material comprising desirable and vegetable nutrients to be included in the soft serve, such as, for example beta-glucan, while at the same time achieving a stable emulsion. In particular, oat-derived material comprising oat protein and oat fat has been included, together with carbohydrates of the oat-derived material.

The specific composition, with the above stipulated levels of oat-derived material, vegetable fat, sugars, maltodextrin, emulsifier and stabilizer blend and water unexpectedly allow provision of a vegetable based soft serve associated with desirable emulsification properties and provides desirable organoleptic properties, while also providing stability of the composition over time, for example, in terms of a stable emulsion. It is surprising and appreciated that the combination of the ingredients within their respective intervals together functions to provide the desirable properties of the soft serve composition.

The vegetable fat and the sugars are in addition to any vegetable fat and sugars comprised by the oat-derived material. Thus, and for example, if the oat-derived material comprises oat fat, that oat fat is not included in the vegetable fat. Any water included in the oat-derived material shall, however, be calculated, viewed and/or treated as a portion of or part of the water, as further discussed and explained herein below.

The sugars may comprise one or more of sucrose, dextrose and sugars from glucose syrup.

The glucose syrup may be, for example, a solution of saccharides obtained by hydrolysis of starch, such as wheat starch or corn starch, characterised by a high polysaccharides content. The glycose syrup may, for example, have a dry content of 70-90% by weight, such as 75-85% by weight, or 79-81% by weight of carbohydrades. Of the dry content of the glucose syrup, for example 20-50% by weight may be sugars. Of the sugars present in an amount of 5 to 25% by weight of the soft serve composition, 1-3%, or 1-2%, by weight of the soft serve composition, may be sugars from glucose syrup.

As an alternative to glucose syrup in solution, dry glucose may be used, or a glucose syrup in dry form or essentially without water.

According to one example, the glucose syrup may have a content of dry matter which comprises dextrose, maltose, maltotriose, and higher sugars, for example at levels of 15-19%, 11-15%, 11-15%, and 55-60%, respectively, by weight of the dry matter.

The non-dairy soft serve composition may further comprise a buffering agent. The buffering agent may be selected from suitable food acidity regulators.

The composition may further comprise other ingredients and additives, for example, the composition may comprise one or more of salt, coloring agents, flavorings, vitamins etc. Flavorings may include vanilla, chocolate (cocoa), strawberry, raspberry, or blueberry, such as vanilla and/or cocoa.

The salt (NaCl) may be plain table salt or sea salt. The amount of salt may be 0.05% to 1%, such as 0.06 to 0.5% by weight of the composition.

The emulsifier and stabiliser blend may be present in an amount of 0.25 to 4% by weight of the soft serve composition, and the emulsifier and stabiliser blend may comprise one or more compounds selected from the group consisting of comprising mono- and di-glycerides of fatty acids, guar gum, and gellan gum.

In addition, the emulsifier and stabilizer blend may comprise additives or agents, such as, for example, filling agents.

In addition to the mono- and di-glycerides of fatty acids, guar gum, and gellan gum, the group of the emulsifier and stabiliser blend, present in an amount of 0.25-4% by weight of the soft serve composition, may comprise starch, such as corn starch.

The emulsifier and stabiliser blend may be present in an amount of 0.25-1.25, or 0.5-1%, by weight of the soft serve composition. The emulsifier and stabiliser blend may be present in an amount of 0.25-1.25, or 0.5-1%, by weight of the soft serve composition, wherein the emulsifier and stabiliser blend contains at least 90% by weight, or 95-100% by weight, or 100% by weight, of one or more, or all of: mono- and di-glycerides of fatty acids, guar gum, and gellan gum.

The levels of the emulsifier and stabilizer blend, in combination with the specific compounds of the of emulsifier and stabilizer blend lend the soft serve composition specifically well suited properties, including, for example, creaminess to the soft serve and allows build up of a stable suspension or emulsion of fat in water.

The vegetable fat may comprise coconut fat. The coconut fat may be non-hydrogenated. The non-hydrogenated coconut oil may be referred to as coconut oil.

Other vegetable fats may be used in combination with coconut fat, or instead of coconut fat.

In addition to the vegetable fat, the soft serve composition may comprise vegetable fat from the oat-derived material.

The water may be present in an amount of 55 to 75% by weight of the composition.

The water is the total water of the composition, i.e. any water present in the composition which may have been added as free water and/or any water present in or provided with other ingredients of the soft serve composition. In particular the oat-derived material may be provided as aqueous liquid, such as, for example, in form of a liquid oat base or an oat drink, sometimes referred to as an oat milk, in which case the water provided with the oat-derived material is included in the amount of water, for example the 55 to 75% by weight of the composition. As a further example, all water of the soft serve composition may be added or provided with the oat derived material, for example if the oat derived material is provided as a relatively water diluted suspension of oat-derived material. As yet a further example, the oat-derived material may be provided as a dry powder or formulation, for which case essentially all or all water present in the soft serve composition may be provided as free water added to the soft serve composition.

The oat-derived material may have been obtained from treatment of oats comprising degradation of starch.

For example, starch of the oats may be subjected to enzymatic hydrolysis, such as hydrolysis by amylase. The amylase may be one or more of α-amylase and β-amylase. During the hydrolysis, or degradation of starch, starch of the oats may be converted to lower types of starch, including sugars, such as, for example, maltose.

As such, the oat-derived material may be a liquid, aqueous, oat base or an oat drink, or a combination thereof. The oat derived material may also be such an oat base in dried form.

Such an oat-derived material, or a liquid oat base or an oat drink, may be obtained from degradation of starch of oats.

The oat base or oat drink may comprise, by dry weight of the oat base or oat drink, 5-20% protein, and 3-15% fat, and optionally 10-80% carbohydrates, including sugars.

Typically, the liquid oat base or oat drink may comprise sugars 2-8%, fibres 0.2-3% (out of which 0.1-1% of the oat base or oat drink is beta glucans), fat 0.0-2.5%, and proteins 0.5-2.5%, by weight of the oat base or drink. The dry matter of the liquid oat base may be, for example, 10-20%, eg. 12-14%, or 13% or 14%, by weight of the liquid oat base or oat drink.

The liquid oat base or oat drink may comprise the following, expressed in % by weight of the liquid oat base: sugars 4-6%, or eg. 5%; beta glucans 0.25-0.75%, or eg. 0.5%; fat 0.5-1%, or eg. 0.8%; and proteins 1-2%, or eg. 1.5%, wherein the dry matter of the liquid oat base or oat drink may be 12-14% by weight. Carbohydrates, including the sugars, may be present at 7-10.5%, or eg. 9.5%. Such an oat base may comprise, by dry weight of the oat base or oat drink, sugars 30-40%, or eg. 35%; beta glucans 2-6%, or eg. 4%; fat 4-8%, or eg. 6%; and proteins 9-13%, or eg. 11%. Carbohydrates, including the sugars, may be present at 65-80%, or eg. 73%.

The oat-derived material may be a liquid oat base or oat drink obtained from treatment of oats comprising treatment with amylase.

It has been surprisingly found that the liquid oat base as described herein above, which may be viewed as having a complex composition of several compounds, provides improved organoleptic properties to the soft serve, and that it can be used with the other ingredients and still form a stable suspension.

The oat-derived material may be a deamidated oat-derived material.

Such a deamidated oat derived material, may be an oat-derived material wherein oat proteins have been subjected to deamidation and thereby converted to more water soluble proteins, for example using protein deamidase, or protein glutaminase.

It has unexpectedly been found that presence of deamidated oat proteins in the soft serve composition plays a role in further improving organoleptic properties and improved stability of emulsion of the soft serve composition. A deamidated oat-derived material has higher levels of water soluble proteins, which is believed to have an effect on improved emulsion stability.

The deamidated oat-derived material may have been subjected to treatment with protein deamidase, for example protein glutaminase.

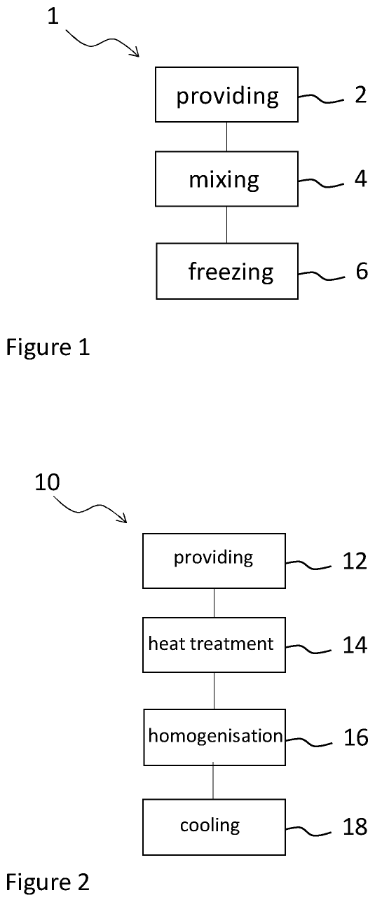

With reference to FIG. 1, a method 1 for producing a non-dairy soft serve from the non-dairy soft serve composition according to the first aspect is illustrated. The method 1 comprises: providing 2 the non-dairy soft serve composition according to the first aspect; mixing 4 in air; and freezing 6 of the non-dairy soft serve composition.

With reference to FIG. 2, a method 10 for manufacturing of a non-dairy soft serve composition according to the first aspect is illustrated. The method 10 comprising: providing 12 a base composition comprising: an oat-derived material, vegetable fat, sugars, maltodextrin, emulsifier and stabiliser blend, and water; subjecting the base composition to heat treatment 14 at a temperature above 125° C. followed by cooling to a temperature below 85° C.; subjecting the base composition to homogenization 16 followed by cooling 18 below 30° C., thereby obtaining the non-dairy soft serve composition.

### Example 1—Non-Dairy Soft Serve Composition

A non-dairy soft serve composition was manufactured according to the method for producing a non-dairy soft serve composition according to the second aspect, which soft serve composition will now be described as an example.

In this example, the oat-derived material was a deamidated liquid oat base. The liquid oat base for this example may be obtained from treatment of oats comprising treatment with amylase, and using protein deamidase for providing deamidated oat proteins. The liquid oat base had a dry matter of 14% by weight of the liquid oat base, and was mixed with other ingredients of the soft serve composition as listed in table 1. The total weight of the batch was 13 000 kg. The composition was mixed and homogenized until a homogenous mixture was achieved. A two-stage homogenizer is used with a pressure of 200/50 bar, but it shall be realised that other suitable means of homogenization may be used.

TABLE 1

| | Amounts (% by |
|---|---|
| Ingredient | weight) |
| Oat Base³, deamidated (14% dry matter) | 52.00 |
| Water | 19.15 |
| Sugar (Sucrose) | 11.5 |
| Dextrose | 2.0 |
| Glucose Syrup¹ | 6.0 |
| Table salt | 0.05 |
| Emulsifier and stabilizer Blend with starch² | 1.75 |
| Coconut fat (non-hydrogenated) | 3.5 |
| Maltodextrine | 4.00 |
| Flavouring | 0.05 |
| Total | 100 |

¹Note:
The glycose syrup comprises 75%-85%, or about 80%, by weight of dry solids comprising about 25-35%, or about 29%, by weight of sugars. Thus, the sugar provided with the glucose syrup is about 1.1-1.8%, or about 1.4%, by weight of the soft serve composition. The content of sugar of table 1, including sugars from the glycose syrup, the sucrose, and the dextrose, thus may be about 15%.
²Note:
The emulsifier and stabiliser blend comprises corn starch, mono- and di glycerides of fatty acids, guar gum, and gellan gum. Of the emulsifier and stabiliser blend, 0.75%, by weight of the soft serve composition consisted of mono- and di glycerides of fatty acids, guar gum, and gellan gum, and the emulsifier and stabiliser blend was further mixed with 1%, by weight of the soft serve composition, of corn starch.
³Note:
The deamidated oat base was an aqueous liquid oat base having a dry matter of 14%, derived from oats, the remaining 86% being water. The total amount of water in the soft serve composition of the example 1, thus, has a water content of about 64% from added water and added via the oatbase. Further, the 14% dry matter of the oat-derived material, of the liquid oat base provides about 7.3, or about 7%, dry matter by weight of the soft serve composition.

Different compositions of the oat derived material have been used. The liquid oat base of table 1, comprised the following expressed in % by weight of the liquid oat base: sugars 4-6%, or 5%; beta glucans 0.25-0.75%, or 0.5%; fat 0.5-1%, or 0.8%; and proteins 1-2%, or 1.5%. Carbohydrates, including the sugars, was present at 7-10.5%, or 9.5%. Thus, within the following intervals, expressed as % by dry weight of the liquid oat base, sugars 30-40%; beta glucans 2-6%; fat 4-8%; and proteins 9-13%. Carbohydrates, including the sugars, was present at 65-80%.

It can be concluded that the non-dairy soft serve composition of the example has ingredients within the first aspect and, further, within the following ranges: Oat-derived material, such as liquid aqueous oat base, comprising dry matter in an amount of 5-10%, or 7%, by weight of the soft serve composition; the vegetable fat is present in an amount of 2 to 5%, or 3.5%, by weight of the soft serve composition; the sugars are present in an amount of 10 to 20%, or 15%, by weight of the soft serve composition, and comprises sucrose, sugar from glucose syrup, and dextrose; the maltodextrin is present in an amount of 3 to 5%, or 4%, by weight of the soft serve composition; mono- and di-glycerides of fatty acids, guar gum, and gellan gum of the emulsifier and stabiliser blend are present in an amount of 0.25 to 1.25%, or 0.8%, by weight of the soft serve composition; and the water is present in an amount of 60 to 70%, or 64%, by weight of the soft serve composition.

Starch mixed with mono- and di glycerides of fatty acids, guar gum, and gellan gum of the emulsifier and stabiliser blend was available and used for the experiment. The starch may be considered a carrier material for the blend. Emulsifier and stabilizer blends without the starch was also used in experiments with desirable results.

The emulsifier and stabiliser blend used in example 1, may be described as an emulsifier and stabiliser blend present in an amount of 0.25-1.25%, or 0.5-1%, or more precisely 0.8% by weight of the soft serve composition comprising at least 90% by weight, or 95-100% by weight, or 100% by weight, of mono- and di-glycerides of fatty acids, guar gum, and gellan gum. For this example, the emulsifier and stabiliser blend being was mixed with starch (1% by weight of the soft serve composition).

It has been unexpectedly found from experiments, including Example 1 discussed here, that non-dairy soft serves can be made with a soft serve machine and have been found to provide in particular suitable properties in terms of stability, taste, and organoleptic properties. It is a challenge to provide a non-dairy soft serve having those properties. The deamidated oat base showed to improve emulsification stability, and was used in example 1, although it is, alternatively, possible to provide soft serves using oat base which has not undergone deamidation. The use of maltodextrin, such as the 4%, within the interval 3-5%, used in example 1, was shown to be in particular suitable together within the levels of fat of the first aspect, and example 1, and in particular with the coconut oil. Thereby a non-dairy soft serve with a low level of fat may be provided. The levels of maltodextrine is believed to provide eg. creaminess and body even with low fat, thus acting in replacement of fat of the soft serve. Further, the maltodextrine is belied to improved other sensory sensations, assists in water binding and stabilize firmness.

The oat-derived material seems to provide sensory benefits, and, for example, adds to complexity of taste, while at the same time allowing stable emulsions, also over time.

### Example 2—Production of a Non-Dairy Soft Serve from the Non-Dairy Soft Serve Composition

A commercially available soft serve machine was used together with the soft serve composition as described under example 1. The non-dairy soft serve composition was added to the machine. Air was mixed into the soft serve composition, and the soft serve composition was frozen within the machine. A soft serve was extracted from the machine. The soft serve composition was consumed and found desirable. The overrun was above 45%. No undesirable crystal growth was perceived.

### Example 3—Method for Manufacturing of a Non-Dairy Soft Serve Composition

The non-dairy soft serve composition of examples 1 and 2 was manufactured using a method that will now be described in further detail. The soft serve composition was, for the example, manufactured in a batch method, although other suitable methods may be used, and the total weight of the ingredients as listed in table 1 was 13000 kg.

A base composition was provided into a tank, the base composition comprised the following ingredients, in particular with amounts presented in table 1: an oat-derived material (deamidated oat base, 14% dry matter), vegetable fat (coconut oil), sugars, maltodextrin, emulsifier and stabiliser blend, and water. The base composition was subjected to heat treatment at a temperature above 125° C. followed by cooling to a temperature below 85° C., thereby the mixture was UHT-treated, followed by subjecting the base composition to homogenization, eg. at 200/50 bar pressure, followed by cooling below 30° C., or more precisely for example 3, to 11° C., thereby obtaining the non-dairy soft serve composition. The cooling may, for this and other examples, be 5 to 15° C., which has been found suitable. This temperature may be described as a filling temperature.

The homogenized and emulsified composition was found to be stable over time and described as a stable emulsion.

1. A non-dairy soft serve composition, the composition comprising:
an oat-derived material comprising dry matter in an amount of 1 to 15% by weight of the soft serve composition;
vegetable fat present in an amount of 0.5 to 10% by weight of the soft serve composition
sugars present in an amount of 5 to 25% by weight of the soft serve composition,
maltodextrin present in an amount of 2 to 6% by weight of the soft serve composition,
an emulsifier and stabilizer blend, and
water.

2. The non-dairy soft serve composition according to claim 1, wherein the sugars comprise one or more of sucrose, dextrose and sugars from glucose syrup.

3. The non-dairy soft serve composition according to claim 1,
wherein the emulsifier and stabilizer blend is present in an amount of 0.25-4% by weight of the soft serve composition, and
wherein the emulsifier and stabilizer blend comprises one or more compounds selected from the group consisting of comprising mono- and di-glycerides of fatty acids, guar gum, and gellan gum.

4. The non-dairy soft serve composition according to claim 1, wherein the vegetable fat comprises coconut fat, preferably non-hydrogenated.

5. The non-dairy soft serve composition according to claim 1, wherein the water is present in an amount of 55 to 75% by weight of the composition.

6. The non-dairy soft serve composition according to claim 1, wherein the oat-derived material has been obtained from treatment of oats comprising degradation of starch.

7. The non-dairy soft serve composition according to claim 1, wherein the oat-derived material is a liquid oat base or an oat drink, or a combination thereof.

8. The non-dairy soft serve composition according to claim 1, wherein the oat-derived material is a deamidated oat-derived material.

9. The non-dairy soft serve composition according to claim 1, wherein the oat-derived material comprises one or more of monosaccharides, disaccharides, for example, maltose, oligosaccharides, and fibers, including β-glucan, the oat derived material may further comprise oat protein and oat fat.

10. The non-dairy soft serve composition according to claim 1, wherein
the oat-derived material comprises dry matter in an amount of 5-10% by weight of the soft serve composition;
the vegetable fat is present in an amount of 2 to 5% by weight of the soft serve composition
the sugars are present in an amount of 10 to 20% by weight of the soft serve composition, and comprises sucrose and sugar from glucose syrup, and dextrose,
the maltodextrin is present in an amount of 3 to 5% by weight of the soft serve composition,
the emulsifier and stabilizer blend is present in an amount of 0.25 to 1.25% by weight of the soft serve composition, and
the water is present in an amount of 60 to 70% by weight of the soft serve composition.

11. A method for producing a non-dairy soft serve from the non-dairy soft serve composition according to claim 1, the method comprising:
providing the non-dairy soft serve composition according to claim 1,
mixing in air, and
freezing of the non-dairy soft serve composition.

12. The method according to claim 11, wherein the method for producing a non-dairy soft serve from the non-dairy soft serve composition is performed using a soft serve apparatus.

13. A method, for manufacturing of a non-dairy soft serve composition according to claim 1, the method comprising:
providing a base composition comprising:
an oat-derived material, vegetable fat, sugars, maltodextrin, an emulsifier and stabilizer blend, and water;
subjecting the base composition to heat treatment at a temperature above 125° C. followed by cooling to a temperature below 85° C.;
subjecting the base composition to homogenization followed by cooling below 30° C., thereby obtaining the non-dairy soft serve composition.

14. The method according to claim 13, wherein the vegetable fat is subjected to melting by heating prior to being provided for the base composition.

15. The method according to claim 13, further comprising mixing the base composition, following the providing the base composition, and preceding the subjecting the composition to heat treatment.

16. A non-dairy soft serve comprising the composition according to claim 1.
